(19) United States
(12) Patent Application Publication
(10) Pub. No.: US 2026/0319982 A1
(43) Pub. Date: Oct. 15, 2026

(54) ADDRESS PROGRAMMING IN MULTI-SENSOR SYSTEMS WITH A SHARED BUS

(71) Applicant: Allegro MicroSystems, LLC, Manchester, NH (US)

(72) Inventor: Sebastian Schäfer, St Leon Rot (DE)

(73) Assignee: Allegro MicroSystems, LLC, Manchester, NH (US)

(21) Appl. No.: 19/176,884

(22) Filed: Apr. 11, 2025

(51) Int. Cl. G06F 13/36; B60R 16/023; G07C 5/08

(52) U.S. Cl. CPC G06F 13/36; B60R 16/023; G06F 2213/40; G07C 5/0808

(57) ABSTRACT

According to one aspect, a sensor includes: one or more sensing elements configured to generate a sensor output signal responsive to a measured quantity, a non-volatile memory, and a processor. The processor is configured to receive an address programming command from a controller via a shared bus, the address programming command including a new address to be assigned to one of a plurality of sensors connected to the controller via the shared bus; determine whether to process the address programming command based at least in part on comparing the measured quantity to one or more predetermined threshold values; and in response to determining to process the address programming command, store the new address to the non-volatile memory.

### BACKGROUND

Various types of systems employ multiple sensors connected to a system controller (e.g., a microcontroller unit or MCU) via one or more signal pathways (or “lines”). Each line may comprise one or more wires connected to a separate input (e.g., pin) of the controller. For example, in vehicle systems, numerous sensors can be employed to monitor operating parameters such as current, speed, angle, linear position, rotational direction, temperature, etc. of an article associated with a control module, such as a power steering module, a fuel injection module, an anti-lock brake module, etc. Electric vehicle systems and other systems may employ multiple current sensors to monitor operation of a 3-phase inverter for converting direct current (DC) into alternating current (AC). Vehicle sensors can be connected to a system controller, such as an Electronic/Engine Control Unit (ECU) or Engine Control Module (ECM).

### SUMMARY

Two types of signal pathways may be provided between the sensors and the system controller. The first type of signal pathways, referred to herein as “sensor output lines,” are for transmitting sensor data (e.g., measured quantities sensed by the sensor) to the controller (e.g., using analog signals). The second type of signal pathways, referred to herein as “communication lines,” allow the controller to send commands to the sensors (e.g., using a digital communications protocol). A sensor that is powered on may transmit an output signal to the controller on a continuous, or near-continuous, basis. In contrast, the system controller may issue commands to the sensors infrequently.

A system controller may issue (e.g., send) different types of commands to a sensor. For example, a controller may command a sensor to execute a calibration or self-test routine. As another example, a controller may command a sensor to adjust its gain or sensitivity. As another example, a controller may issue a diagnostic read-out command to individual sensors to read die temperature or other sensor characteristics. Some commands can be described as “read-only,” meaning they do not change the operation of the sensor and may simply involve the sensor returning a value from a memory register (e.g., EEPROM, Flash, or MRAM).

With the large number of sensors in modern applications, the system controller inputs (e.g., pins) available are often limited. Thus, rather than having separate communication lines for each sensor, a shared communication bus (single line) may be used for sending controller commands. The shared communication bus may be a serial bus that connects multiple sensors to the same controller. A single-line, digital serial communications protocol such as UART (universal asynchronous receiver/transmitter) may be used for exchanging data over the shared communication bus. Other digital communications protocols may also be used.

In a multi-sensor system, it may be necessary or desirable for the controller to communicate with (e.g., issue commands to) particular, individual sensors via the shared communication bus. For example, as part of end-of-line (EOL) testing of the system (e.g., before an assembled vehicle leaves the factory), the controller can command each sensor to run a calibration or self-test routine. As another example, the controller may periodically issue diagnostic read-out commands to read the die temperature or other characteristics of particular sensors. To ensure reliable communication (e.g., to ensure that only one sensor responds to a given controller command), each sensor connected to the shared communication bus can be assigned a unique address on which it listens for commands from the controller. The unique address can be a numerical value encoded as one or more bits, for example.

Conventionally, a sensor's address is set using one of the following approaches: fixed or hardcoded during manufacture of the sensor, pre-programmed by the sensor manufacturer, or programmed during assembly/manufacture of the system in which the sensor is used (e.g., during assembly/manufacture of a vehicle). With the first two approaches, the sensor manufacturer can assign different addresses to different sensor parts, e.g., using a random assignment scheme. This presents a risk that two different parts installed in the same systems have the same address and thus of unreliable communications. To mitigate this risk, it may be necessary to loop over all possible addresses to detect duplicate addresses, which can increase EOL test time. It can also complicate inventory management as system manufacturers may prefer to have identical instances of a given sensor part in stock and in their system. Programming is conventionally done by applying a voltage or external resistor to one or more pins of the sensor integrated circuit (IC) dedicated to this purpose, however this can increase the overall device pin count and/or require additional components that results in increased device size and cost, as well as increasing assembly/test time.

Described herein are structures and techniques that enable sensor address programming in a multi-sensor system with shared communication bus without the need for fixed addresses and without the need for sensor IC pins dedicated for programming.

According to one aspect of the present disclosure, a sensor includes one or more sensing elements configured to generate a sensor output signal responsive to a measured quantity, a non-volatile memory, and a processor. The processor is configured to receive an address programming command from a controller via a shared bus, the address programming command including a new address to be assigned to one of a plurality of sensors connected to the controller via the shared bus; determine whether to process the address programming command based at least in part on comparing the measured quantity to one or more predetermined threshold values; and in response to determining to process the address programming command, store the new address to the non-volatile memory.

The sensor output signal can be provided to the controller via a dedicated line. The sensor output signal can be a digital or analog signal. The processor can be configured to listen for the address programming command from the controller at a factory default address. The processor can be configured to listen for the address programming command from the controller at a previously assigned address. The processor can be configured to listen for the address programming command from the controller at an address selected from among a set of predetermined addresses. The processor can be configured to select the address from among a set of predetermined addresses based at least in part on the measured quantity. The determination of whether to process the address programming command can include determining if the measured quantity is greater than or less than one of the predetermined threshold values, or between two of the predetermined threshold values. The processor can include one or more latched comparators used for the comparing of the measured quantity to one or more predetermined threshold values. The processor can further be configured to power cycle the sensor after storing the new address. The processor can further be configured to send a response to the controller acknowledging that the address programming command was processed.

According to another aspect of the present disclosure, a system includes a controller connected to a plurality of sensors via a shared bus. The controller is configured to program an address of at least one of the sensors using a process including: exciting the sensor above or below one or more predetermined threshold values; and sending an address programming command, via the shared bus, to a predetermined address at which the sensor is listening.

The controller can be configured to program addresses of two or more sensors (e.g., all sensors) of the plurality of sensors using the process. The controller can be configured to wait for a first of the two or more sensors to process its address programming command before sending the address programming command to a second of the of the two or more sensors. The controller can be configured to program the two or more sensors in a substantially parallel fashion.

According to another aspect of the present disclosure, a method includes: generating, by a sensor, a signal responsive to a measured quantity; receiving, by the sensor, an address programming command from a controller via a shared bus, the address programming command including a new address to be assigned to one of a plurality of sensors connected to the controller via the shared bus; determining, by the sensor, whether to process the address programming command based at least in part on comparing the measured quantity to one or more predetermined threshold values; and in response to determining to process the address programming command, storing the new address to a non-volatile memory of the sensor.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a block diagram of a multi-sensor system with separate communication lines for each sensor.

FIG. 2 is a flow diagram showing a process that can be implemented and executed within a sensor for communicating with a system controller over a communication line dedicated to the sensor.

FIG. 3 is a block diagram of a multi-sensor system with a shared communication bus.

FIG. 4 is a block diagram showing a partial implementation of sensor capable of address programming.

FIG. 5A is a flow diagram showing a process that can be implemented and executed within a sensor for communicating with a controller via shared communication bus.

FIG. 5B is a flow diagram showing a subprocess that can be used in conjunction with the process of FIG. 5A to conditionally handle address programming commands received via the shared communication bus.

FIG. 6 is a flow diagram showing a process that can be implemented and executed within a system controller to program the address of multiple sensors in a serial fashion.

FIG. 7 is a flow diagram showing a process that can be implemented and executed within multiple sensors to enable a system controller to program a group of sensors via a shared communication bus.

FIG. 8 is a flow diagram showing a process that can be implemented and executed within a system controller to program addresses of a group of sensors in a substantially parallel fashion.

The drawings are not necessarily to scale, or inclusive of all elements of a system, emphasis instead generally being placed upon illustrating the concepts, structures, and techniques sought to be protected herein.

### DETAILED DESCRIPTION

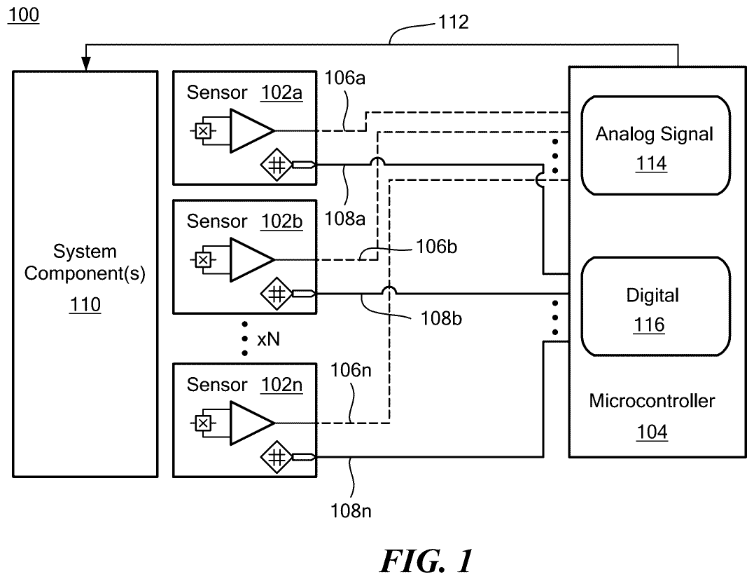

FIG. 1 shows a simplified example of a multi-sensor system 100 with separate, dedicated communication lines for each sensor. Illustrative system 100 includes a plurality of sensors 102a, 102b, . . . , 102n (102 generally) each connected to a system controller 104 via a respective one of a plurality of dedicated sensor output lines 106a, 106b, . . . , 106n (106 generally) and also via a respective one of a plurality of dedicated communication lines 108a, 108b, . . . , 108n (108 generally). Sensors 102 can be arranged (e.g., physically positioned) and configured to monitor one or more operating parameters (e.g., current, speed, angle, linear position, rotational direction, temperature, etc.) of one or more system components 110. In some examples, multiple sensors 102 may monitor operation parameters of the same system component 110 (e.g., three sensors may be used to monitor a 3-phase inverter). In some examples, different sensors 102 may monitor operation parameters of different system components 110. In a vehicle system example, components 110 can include a power steering module, a fuel injection module, an anti-lock brake module, one or more 3-phase inverters, etc.

A given sensor 102 can include analog and/or digital circuitry configured to monitor one or more operating parameters of one or more system components 110, to generate a sensor output signal responsive to measured quantities of the one or more operating parameters on the respective sensor output line 106, and to receive and process controller commands via the respective communication line 108. A sensor 102 can include memory registers on, e.g. EEPROM, Flash, or MRAM, used to store settings (e.g., initialization, configuration, and/or calibration settings) and/or measured quantities (e.g., temperature, current, etc.).

Sensors 102 can include, for example, current sensors, speed sensors, angle sensors, linear position sensors, rotational direction sensors, and/or temperature sensors.

In some examples, a sensor 102 can include one or more magnetic field sensing elements. A magnetic field sensing element can be, but is not limited to, a Hall Effect element, a magnetoresistance element, a magnetotransistor, or an inductive coil. Magnetoresistance elements include, for example, a semiconductor magnetoresistance element such as Indium Antimonide (InSb), a giant magnetoresistance (GMR) element, an anisotropic magnetoresistance element (AMR), a tunneling magnetoresistance (TMR) element, and a magnetic tunnel junction (MTJ). A magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

In the example of FIG. 1, system controller 104 can include analog circuitry 114 to receive and sensor output signals from sensors 102 via sensor output lines 106 and digital circuitry 116 to generate and transmit commands to sensors 102 via communication lines 108. In other examples, the sensor output signals can be digital signals, i.e., sensor output lines 106 can carry information using a digital communication protocol such as sigma-delta, Serial Peripheral Interface (SPI), Single Edge Nibble Transmission (SENT), etc. The digital and/or analog circuitry can be further configured to control operation of the one or more system components via one or more control lines 112. For example, in a vehicle system, controller 104 can control operation of a 3-phase inverter (turning it on/off, controlling its sinusoidal waveform, etc.) via control lines 112. In some examples, system controller 104 can include one or more MCUs. In some examples, controller 104 can correspond to an ECU or ECM. It should be appreciated that the system controller 104 illustrated in FIG. 1 is merely illustrative and not intended to show all components and features that may be found in a system controller employed within a given real-world application.

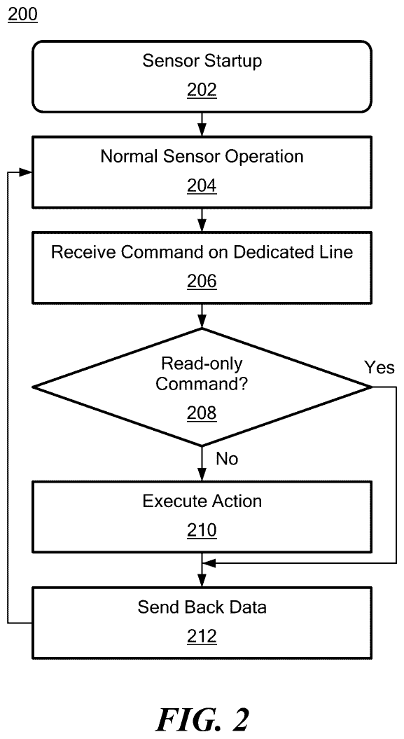

FIG. 2 shows an example of a process 200 that can be performed within a sensor for communicating with a system controller over a separate communication line dedicated to the sensor. For example, process 200 can be implemented and executed by any sensor 102 of FIG. 1. Process 200 can begin at block 202 when the sensor starts up (e.g., powers on). At step 204, the sensor can begin its normal sensing operation mode. For example, the sensor can measure one or more operational parameters of a system component and generate an output signal responsive thereto. Step 204 can occur on a continuous or near-continuous basis while the sensor is powered on. At step 206, the sensor can receive a command from the controller (e.g., MCU) on a dedicated communication line. If, at block 208, the command is a read-only command (e.g., a temperature read-out command), then process 200 can skip to step 212. Otherwise, at step 210, the sensor can execute one or more actions associated with the command (e.g., adjusting a gain of the sensor, performing a self-test or calibration, etc.). At step 212, the sensor can send data back to the controller. The sensor can resume its normal operation by returning to step 204.

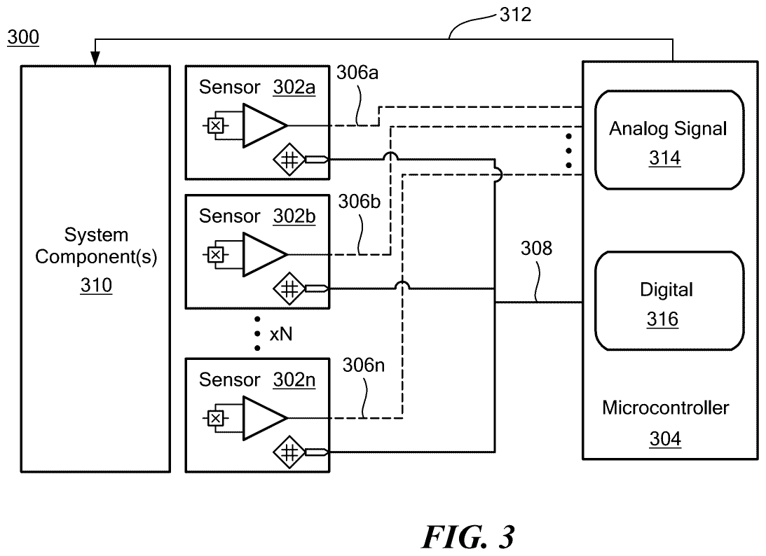

FIG. 3 shows a simplified example of a multi-sensor system 300 with a shared communication bus. Illustrative system 300 includes a plurality of sensors 302a, 302b, . . . , 302n (302 generally) each connected to a system controller 304 via a respective one of a plurality of dedicated sensor output lines 306a, 306b, . . . , 306n (306 generally). Multiple sensors 302 (e.g., all sensors 302) may also be connected to system controller 304 via a single, shared communication bus 308 (e.g., a serial bar). Sensors 302 can be arranged and configured to monitor one or more operating parameters of one or more system components 310, similar to as described above for FIG. 1.

System controller 304 can include analog circuitry 314 to receive and sensor output signals from sensors 302 via sensor output lines 306 and digital circuitry 316 to generate and transmit commands to sensors 302 via the shared communication bus 308. A command generated by controller 304 can include a “target address” (e.g., a UART address) that specifies which sensor 302, or sensors, should execute or otherwise process that command. Each sensor 302 can be assigned an address on which it listens for commands. That is, a sensor 302 can choose to process a command, or not, based at least in part on whether the command's target address is equal to the sensor's assigned address. The controller circuitry can be further configured to control operation of the one or more system components via one or more control lines 312, similar to as described above for FIG. 1.

A given sensor 302 can include analog and/or digital circuitry configured to monitor one or more operating parameters of one or more system components 310 and to generate a sensor output signal responsive to measured values of the one or more operating parameters on the respective sensor output line 306. The sensor circuitry can further be configured to listen for and execute commands sent by controller 304 via the shared communication bus 308. A sensor 302 can include memory registers (e.g., memory registers on EEPROM, Flash, MRAM, or another non-volatile memory device) used to store settings and/or measured values. In particular, the memory registers can be used to store the address assigned to the sensor at which the sensor listens for commands on the shared communication bus 308. A sensor 302 can be assigned a default address (e.g., “0”) that is, for example, set during manufacture of the sensor. In some examples, multiple sensors 302 (e.g., all sensors 302) can be assigned the same default address. For example, all sensors of a given kind may be manufactured with the same default address.

Among various other types of commands described herein, system controller 304 can issue commands for sensors 302 to initialize or update their assigned address. For convenience, such commands are referred to herein as “address programming commands.” An address programming command can include both a target address and a new address to be assigned to the sensor. During processing of an address programming command, a sensor 302 can write or otherwise store the new assigned address in a designated onboard memory register.

As previously discussed, multiple sensors 302 can be assigned the same address (e.g., the same default address). Thus, whereas for other types of commands (e.g., calibration commands) a sensor 302 can choose to process a command by simply comparing the command's target address to the sensor's assigned address, this approach may not be sufficient for initial address programming. Another condition may be used by sensors 302 when deciding whether to process an address programming command issued by controller 304. This additional condition is herein referred to as the “address programming condition” and, when the condition is met, a sensor is said to be in “address programming mode.”

In some examples, a sensor 302 can implement an address programming condition that is based at least in part on a quantity that the sensor is designed to measure, such as magnetic field strength, current magnitude, rotational speed, angular position, linear position, etc. For example, a sensor 302 can enter address programming mode in response to determining that its measured quantity is above/below a predetermined threshold value (e.g., using a comparator). Here, the sensor is said to be in “excited state.” As another example, a sensor 302 can enter address programming mode if its measured quantity is between two predetermined thresholds (e.g., between upper and lower threshold values). Here, the sensor is said to be in a “non-excited state.” Thus, both excited and non-excited states can be used as the basis for address programming conditions. A sensor 302 may consider its measured quantity alone, or in combination with the command's target address, when deciding whether to process an address programming command.

A sensor's 302 measured quantity can be affected by application of an external stimulus (or “excitation”), such as an applied magnetic field, an external signal, etc. Thus, external stimuli can be advantageously used to force one or more particular sensor 302, but not others, into address programming mode. That is, particular sensors 302 can be placed into excited states or non-excited states using external stimuli. For example, an external stimulus can be applied to a particular sensor 302 before or concurrent with controller 304 sending an address programming command, causing that sensor 302 to process the command while other sensors (that may have the same default address) decide not to process the command.

As discussed further below, a sensor 302 can include circuitry to compare its measured quantity to one or more threshold values and to latch the result of the comparison(s) for some period, effectively holding the sensor in or out of address programming mode for that period. This can enable the use of relatively short duration excitations and facilitate the programming of groups of sensors that are physically close to each other, as discussed further below.

An external stimulus can be applied to a sensor 302 by controlling operation of a particular system component 310 that the sensor is arranged and configured to monitor. For example, if a first sensor 302a is configured to monitor the current through a bus bar, the bus bar current be controlled to put the sensor into address programming mode or not. As another example, if a second sensor 302b is configured to monitor rotational speed or position of a gear, the gear speed/position can be controlled to put the sensor into programming mode or not. These are non-limiting examples. In general, any type of system component 310 that that is monitored by a sensor 302 (or multiple sensors) can be controlled to produce an external stimulus, thereby affecting the quantity measured by that sensor and controlling whether the sensor is, or is not, in programming mode.

Controller 304 can control system components 310 (e.g., via control lines 312) so as to produce external stimuli and particular sensors 302. In this way, controller 304 can force particular sensors 302 into programming mode, allowing for systematic programming of all sensors within a system. For example, controller 304 can excite first sensor 302a while sending a first address programming command having a first new address (e.g., “10”), then can excite second sensor 302b while sending a second address programming command having a second new address (e.g., “20”), and so on. In this way, system 300 can program the address of multiple sensors 302 in an automated fashion. Controller 304 can program sensors in a serial fashion (e.g., one at a time) and/or in parallel fashion (e.g., programming a group of sensors at approximately the same time). Such automated, systematic address programming may be incorporated into EOL testing performed by a vehicle manufacturer, for example.

Of note, because controller 304 separately processes output signals from each sensor 302, it necessarily knows the function/purpose of each sensor within the overall system 100 and in relation the system components 310. That is, controller 304 necessarily has information about the overall system state, and can advantageously use this information to initialize the sensor addresses known/expected values based on their function within the system. For example, application software running on a vehicle computer may expect that a proximity sensor on the driver door has a certain address (e.g., “30”) whereas a different proximity sensor on the passenger door has a different address (e.g., “40”). Both proximity sensors may be manufactured with the same default address (e.g., “0”). The techniques, structures, and general concepts described herein allow for assigning such expected address to the correct sensors in an automated fashion.

The techniques and structures described are not limited to initializing sensors that have a factory default address but can also be used to re-program (e.g., update or overwrite) sensor addresses after they have been initialized.

In some examples, system 300 may include one or more control units (not shown) responsible for controlling specific system components 310. In such examples, controller 304 can indirectly control system components 310 by communicating with the component-specific control units. Thus, the control lines 312 depicted in FIG. 3 can represent direct and/or indirect communication pathways between controller 304 and system components 310.

A sensor 302 can listen for address programming commands on its default address (e.g., “0”). Alternatively, a sensor 302 can listen for address programming commands at a predetermined address (e.g., “1”) that is different from the default address. In some examples, a sensor 302 can select which address to listen at from among a set of predetermined addresses, and the selection can be based on the sensor's measured quantity (and thus be responsive to an external stimulus). For example, if the measured quantity is above an upper threshold, the sensor can listen on a first address (e.g., “1”), if the measured quantity is below a lower threshold, the sensor can listen on a second address (e.g., “2”), and if the measured quantity is between the upper and lower thresholds, the sensor can listen on a third address (e.g., “3”).

After processing an address programming command, a sensor 302 can begin listening at its newly assigned address. The sensor 302 may be power cycled before it listens at the new address. For example, sensor 302 can execute a power cycle routine after storing the new address to its memory register. Because the new address can be stored in non-volatile memory, the new address can persist across power cycles and thus can be used by the sensor to listen for commands indefinitely and until it is assigned a new address.

In some systems, multiple sensors 302 may be physically close to each other and/or may be responsible for monitoring the same system component 310. In some cases, it may be challenging if not impossible to excite each sensor in isolation. Thus, a group of sensors may be excited at the same time by controlling a single system component in such a manner that results in each sensor 302 measuring a different quantity. In response, all sensors in the group can concurrently enter address programming mode but with each sensor listening for a command on a different address. This enables controller 304 to issue separate address programming commands to the sensors of the group without having to excite each sensor in isolation from the others. The sensors can use latches to hold their comparison outputs sufficiently long to receive their respective address programming commands via the shared communication bus. Of note, while the controller 304 issue separate programming commands to each sensor, these commands can be sent at approximately the same time (e.g., with a few milliseconds delay between each command) such that all sensors in the group are essentially programmed in parallel.

For example, consider a 3-phase inverter with three sensors used to monitor current on the different phases. To program the sensors as a group, the inverter can be controlled to apply a sinusoidal half-wave current profile, exciting all three sensors. A first sensor can be excited in a positive state (positive current) such that its measured current is greater than a predetermined upper threshold value and, in response, can listen for address programming commands on a first predetermined address (e.g., “1”). A second sensor can be excited in a negative state (negative current) such that its measured current is less than a predetermined lower threshold value and, in response, can listen for address programming commands on a second predetermined address (e.g., “2”). A third sensor can measure its current between the upper and lower threshold values and, in response, can listen for address programming commands on a third predetermined address (e.g., “3”). Controller 304 can then issue three address programming commands, each targeted to one of the three different predetermined addresses. Advantageously, the three sensors can be manufactured identically, e.g., to have the same comparator circuitry, the same upper and lower thresholds, and the same set of predetermined addresses, e.g., “1,” “2,” and “3.”

The approach just described advantageously does not require each sensor to be excited in isolation, which may be impossible or at least impractical in some systems. Moreover, it allows for multiple sensors to be programmed effectively at the same time, without waiting for a previous sensor to be power cycled.

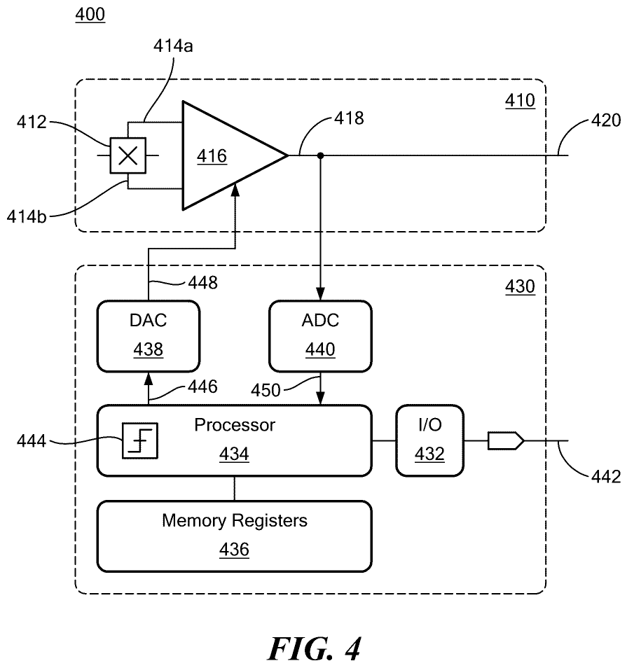

FIG. 4 shows a simplified example of a sensor 400 that may correspond to, for example, any or all sensors 302 of FIG. 3. Sensor 400 can include analog circuitry 410 and digital circuitry 430 (or “digital block”).

Analog circuitry 410 can include one or more sensing elements 412 (e.g., Hall plates or other magnetic field sensing elements), configured to generate a differential signal 414a,b responsive to a magnetic field, current, temperature, etc. Analog circuitry 410 can further include conditioning circuitry 416 configured to condition the differential signal 414a,b to generate a sensor output signal 418 on output line 420. Sensor output line 420 may correspond to a sensor output line 306 of FIG. 3. Conditioning circuitry 416 can include, for example, one or more amplifiers, filters, and/or other analog circuit elements. The sensor output signal 418 can be an analog signal having an amplitude, frequency, phase, or other characteristic responsive to a quantity measured by sensor 400 (e.g., current, speed, angle, linear position, rotational direction, temperature, etc.). The concepts sought to be protected herein are not limited to any particular sensor modality. In some examples, analog circuitry 410 can include circuitry (not shown) to shape the waveform of the sensor output signal 418. For example, such circuitry can generate an output waveform having pulses where the pulse widths and/or pulse edges are, at least in part, indicative of the measured quantity.

Digital circuitry 430 can include an I/O module 432, a processor 434, one or more memory registers 436, a digital-to-analog converter (DAC) 438, and an analog-to-digital converter (ADC) 440. Digital circuitry 430 may correspond to one or more digital signal processors (DSPs), for example.

I/O module 432 can be connected to a shared communication bus 442 (e.g., a serial bus) on which a system controller (e.g., controller 304 of FIG. 3) can transmit commands such as address programming commands, calibration commands, and self-test routine commands. The commands can be received using a serial communications protocol such as UART. I/O module 432 can listen for commands that are targeted to the address assigned to sensor 400. The assigned address can be a factory default, or an address previously programmed into the sensor. The assigned address can be stored in memory registers 436, which may be on EEPROM, Flash, MRAM, or another non-volatile memory device.

Processor 434 can receive a command via I/O module 432 and execute (or at least decide whether to execute) the command in accordance with the command type. For read-only commands, processor 434 may simply read a value (e.g., from a memory register 436) and return it to the controller via the shared bus 442. For some other types of commands, such as calibration commands, processor 434 may adjust one or more parameters used by analog circuitry 410 or otherwise affect a change to the operation of the sensor 400. For example, processor 434 may adjust a gain or offset of an amplifier used to generate sensor output signal 418. As shown in FIG. 4, processor 434 may generate one or more digital control signals 446 that are converted to analog control signals 448 by DAC 438 and then applied to analog circuitry 410 to affect such a change.

In the case of an address programming command, processor 434 can selectively process the command or not using any of the techniques disclosed herein. For example, processor 434 can include one or more comparators 444 that compare the measured quantity indicated by the sensor output signal 418 (or, more particularly, by a digital version 450 of sensor output signal 418 produced by ADC 440) to one or more predetermined threshold values. The threshold values can be stored in memory registers 436 and/or can be fixed/hardcoded within digital circuitry 430. The one or more comparators 444 can be latched such that when a comparator crosses a predetermined threshold value, the comparator output is held for some period. In some examples, latched comparator circuitry can implement both a minimum required time above/below a threshold value to eliminate impact of noise. In some examples, latched comparator circuitry can implement a delay/expiration time to automatically reset the latch after a predetermined period without the need to power cycle the sensor.

Using the one or more comparators 444, processor 434 can, for example, enter programming mode if an programming conditions is met, for example whether: (a) the sensor's measured quantity is or was excited above an upper threshold value, (b) the sensor's measured quantity is or was excited below a lower threshold value, or (c) the sensor's measured quantity is between upper and lower threshold values (i.e., is in a non-excited state). Processor 434 can choose to process an address programming command received via shared bus 422 if and only if it is in programming mode. When processing an address programming command, processor 434 can write the newly assigned sensor address to a memory register 436 and, in some cases, force power cycling of the sensor 400.

In the description above, I/O module 432 is said to listen for address programming commands at single assigned address and, once a command targeted to that address is received, processor 434 is said to decide whether or not to process the programming command based on whether the sensor is excited or not. Other approaches are possible. For example, to allow for programming groups of sensors, processor 434 can periodically read the measured quantity from signal 450 and, compared the measured quantity to one or more threshold values, and based on the comparisons, can select from among a set of predetermined addresses to listen on (e.g., “1”, “2”, or “3”). Processor 434 can then put the sensor into programming mode while listening for programming commands at the selected predetermined address.

Sensor 400 can be realized as integrated circuit (IC) formed on die and packaged. The analog and digital circuit elements shown in FIG. 4 are not intended to depict all possible circuit elements that may be included in a sensor.

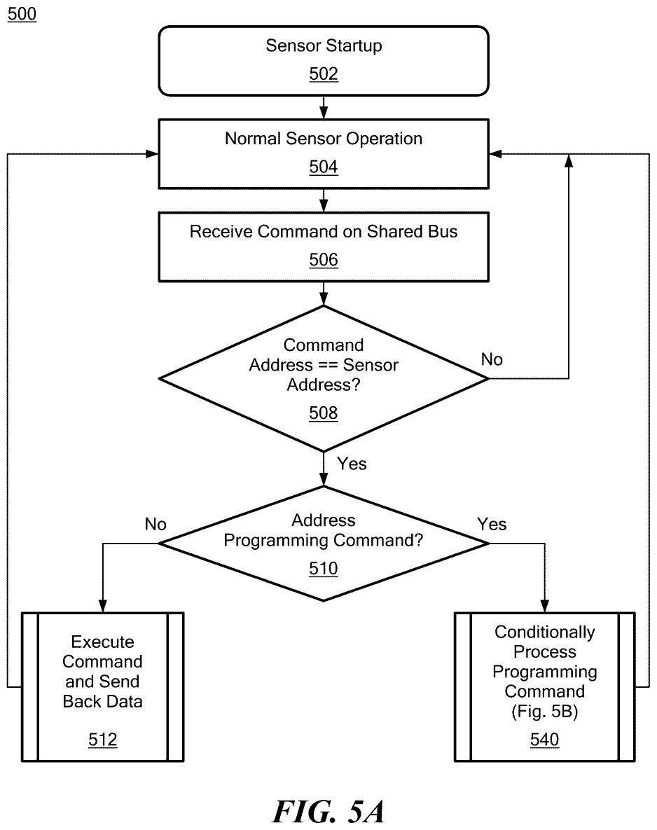

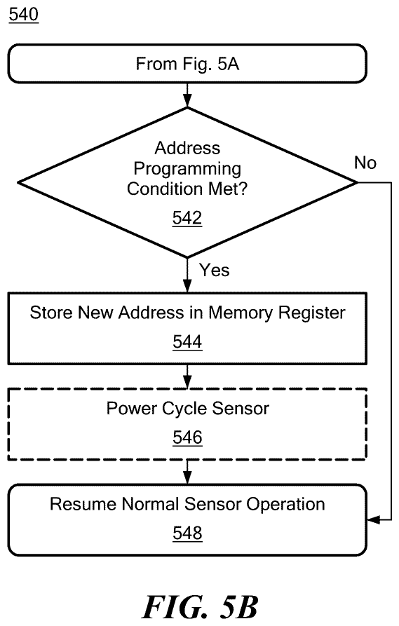

FIGS. 5A and 5B showing processing that can be implemented and executed within a sensor for communicating with a controller via shared communication bus. For example, the processing described in the context of FIGS. 5A and 5B can be implemented within any or all sensors 302 of FIG. 3.

FIG. 5A shows an example of a process 500 for communicating with a system controller over a shared communication bus. Process 500 can begin at block 502 when the sensor starts up (e.g., powers on). At step 504, the sensor can begin its normal sensing operation mode. For example, the sensor can measure one or more operational parameters of a system component and generate an output signal responsive thereto. At step 506, the sensor can receive a command from the controller (e.g., MCU) on a shared communication bus. The command can include a target address. If, at block 508, the command's target address matches the address currently assigned to the sensor (e.g., its factory default address or other previously assigned address), then processing can proceed to block 510. Otherwise, the sensor can ignore the command resume normal processing at step 504. If, at block 510, the command is an address programming command, then process 500 can proceed to subprocess 540 illustrated in FIG. 5B. Otherwise, in subprocess 512, the sensor can execute the command optionally send data back to the controller. Subprocess 512 can correspond to, for example, blocks 208, 210, and 212 described above in the context of FIG. 2.

FIG. 5B illustrates subprocess 540 of FIG. 5A for the case where the sensor receives an address programming command. At block 542, the sensor can determine whether an address programming condition of the sensor is met. Any of the previously discussed conditions may be used. If the condition is met, then process 500 can proceed to step 544. Otherwise, the sensor can resume normal operation at step 548. At step 544, the new sensor address specified by the command can be stored onboard the sensor, such as in a memory register. At step 546, the sensor can be power cycled in order for the newly assigned address to take effect. For some types of sensors, this may be unnecessary and thus step 546 may be omitted or treated as optional. In any case, normal sensor option can resume at step 548. In some examples, the sensor can send a “OK” response (i.e., an acknowledgement) to the controller as part of processing an address programming command (e.g., after storing the new address at step 544). In some examples, the OK response can include the new address.

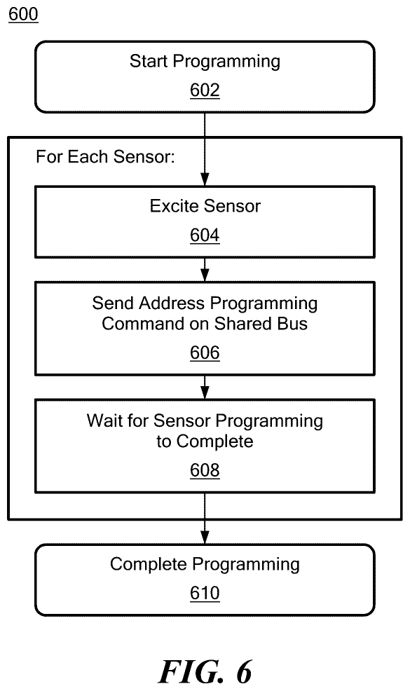

FIG. 6 shows an example of a process 600 that can be implemented and executed within a system controller (e.g., controller 304 of FIG. 3) to program the address of multiple sensors (e.g., sensors 302 of FIG. 3) in a serial fashion. The sensors can be connected to the controller via a shared communication bus. Process 600 can be used, for example, as part of EOL testing of a system (e.g., a vehicle).

Process 600 can begin at block 602. Steps 604, 606, and 608 can then be performed for each of multiple sensors (e.g., all sensors in a system or a subset of sensors). As previously discussed, the system controller can have information about system state including the function/purpose of each sensor within the system. The controller can use this information to loop over all sensors, programming them one at a time.

At step 604, the sensor can be excited such that it is put into programming mode. For example, the system control can control a system component associated with the sensor to apply an external stimulus on the sensor. At step 606, the controller can send an address programming command on the shared bus. The programming command can be targeted to the sensor's currently assigned address (e.g., its factory default address) and can include a new address to be assigned to the sensor. While multiple sensors may receive the programming command, only the sensor currently being excited may choose to process the command. At step 608, the controller can wait for the sensor to complete its programming. In some examples, the controller (e.g., MCU) can wait for an OK response from the sensor (e.g., on OK response with the new address value) before moving on to the next sensor. In other examples, the controller can wait a predetermined amount of time after sending the programming command before moving on to the next sensor.

Process 600 can complete at block 610 after all sensors have been programmed.

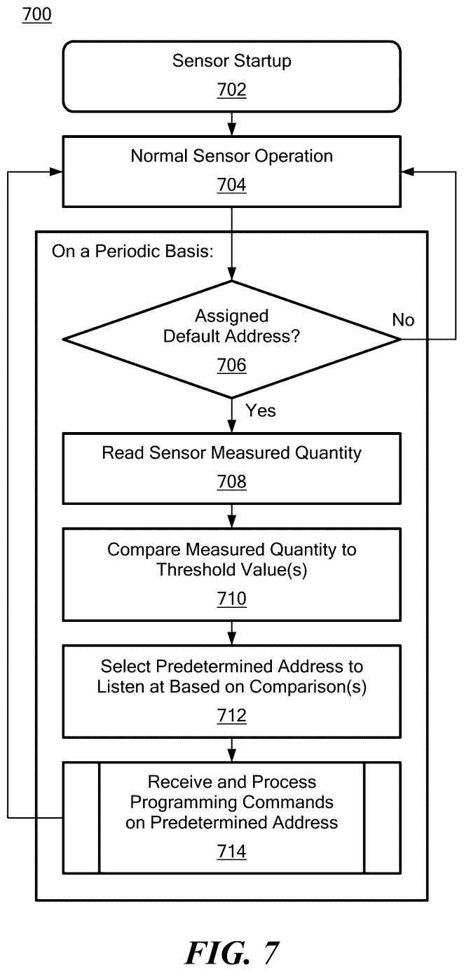

FIG. 7 shows an example of a process 700 that can be implemented and executed within multiple sensors to enable a system controller to program a group of sensors via a shared communication bus. For example, process 700 may be implemented within three sensors used to monitor a 3-phase inverter. Each of the sensors may include multiple different predetermined addresses on which they can listen for address programming commands, and can choose which of those addresses to listen at based on an external stimulus or lack thereof.

Process 700 can begin at block 702 when the sensor starts up (e.g., powers on). At step 704, the sensor can begin its normal sensing operation mode. The remaining blocks 706, 708, 710, 712, and 714 can be performed on a periodic basis.

If, at block 706, the sensor is assigned a default address (e.g., “0”), the process 700 can proceed to step 708. Otherwise, the sensor can resume its normal processing at step 704. At step 708, the sensor can read its measured quantity. At step 710, the sensor can compare its measured quantity to one or more threshold values. For example, the sensor can compare its measured quantity to both an upper and a lower threshold value. At step 712, the sensor can select which of the predetermined addresses to listen at based on the comparisons. For example, if the measured quantity is above the upper threshold, the sensor can listen at a first predetermined address (e.g., “1”), if the measured quantity is below the lower threshold, the sensor can listen at a second predetermined address (e.g., “2”), otherwise the sensor can listen at a third predetermined address (e.g., “3”). Next, at subprocess 714, the sensor can listen for and process an address programming command at the selected predetermined address. Subprocess 714 can include, for example, steps 544 and 546 of FIG. 5B. After address programming is complete, the sensor can resume its normal operation at step 704.

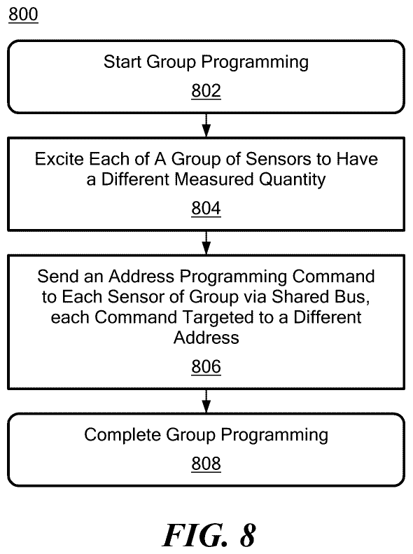

FIG. 8 shows an example of a process 800 that can be implemented and executed within a system controller to program addresses of a group of sensors in a substantially parallel fashion. The controller-side process 800 of FIG. 8 can be used in conjunction with the sensor-side process 700 of FIG. 7, for example.

Process 800 can begin at block 802. At step 804, the controller can excite a group of sensors such that each sensor in the group reads a different measured value. In an example, the controller can apply a sinusoidal half-wave current profile to three sensors arranged to monitor a 3-phase inverter such that a first sensor reads a positive current, a second sensor reads a negative current, and a third sensor is in a non-excited state. This can cause each sensor of the group to listen for address programming commands at a different predetermined address. At step 806, the controller can issue separate address programming commands to each of the different predetermined addresses. Process 800 can complete at block 808 after all sensors of the group have been programmed.

The processes 700 of FIGS. 7 and 800 of FIG. 8 can be used to program a group of sensors having fewer than three, or more than three, sensors.

The approach to group programming described above in the context of FIGS. 7 and 8 is merely one possibility. According to another approach for group programming, all sensors of a group can listen to commands on a factory default address (e.g. “0”) and the controller can send a generic/group programming command on that factory default address. In response to receiving the generic/group programming command, each sensor can set its address based on a threshold/signal condition, such as described above (e.g., each sensor can set its address to either “1”, “2”, or “3” based on low/mid/high signal thresholds). To allow for proper readback of all these commands by the controller, a response delay proportional to the newly programmed sensors address can be used (e.g., a sensor with the new address “1” can send an OK response immediately or after a predetermined delay, a sensor with the new address “2” can wait for twice a predetermined delay before sending an OK response, a sensor with new address “3” can wait for three times a predetermined delay before sending an OK response, etc.).

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory, in a digital signal processor (DSP), and/or in a discrete electronic circuit, which can be analog or digital. A processor or controller can include internal processors or modules that perform portions of the function, operation, or sequence of operations. Similarly, a module can include internal processors or internal modules that perform portions of the function, operation, or sequence of operations of the module. A single processor or other unit may fulfill the functions of several means recited in the claims.

As used in the claims or elsewhere herein, the term “comprising” does not exclude other elements or steps, and the indefinite article “a” or “an” does not exclude a plurality.

As used herein, the term “predetermined,” when referring to a value or signal, is used to refer to a value or signal that is set, or fixed, in the factory at the time of manufacture, or by external means, e.g., programming, thereafter. As used herein, the term “determined,” when referring to a value or signal, is used to refer to a value or signal that is identified by a circuit during operation, after manufacture.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

With respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the detailed description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

Other variations to the disclosed embodiments can be understood and effected by those skilled in the art in practicing the claimed invention, from a study of the drawings, the disclosure, and the appended claims.

The mere fact that certain measures are recited in mutually different dependent claims does not indicate that a combination of these measures cannot be used to obtain an advantage.

Any reference signs in the claims should not be construed as limiting the scope.

All publications and references cited herein are expressly incorporated herein by reference in their entirety.

1. A sensor comprising:
one or more sensing elements configured to generate a sensor output signal responsive to a measured quantity;
non-volatile memory; and
a processor configured to:
receive an address programming command from a controller via a shared bus, the address programming command including a new address to be assigned to one of a plurality of sensors connected to the controller via the shared bus;
determine whether to process the address programming command based at least in part on comparing the measured quantity to one or more predetermined threshold values; and
in response to determining to process the address programming command, store the new address to the non-volatile memory.

2. The sensor of claim 1 wherein the sensor output signal is provided to the controller via a dedicated line.

3. The sensor of claim 2 wherein the sensor output signal is a digital signal.

4. The sensor of claim 2 wherein the sensor output signal is an analog signal.

5. The sensor of claim 1 wherein the processor is configured to listen for the address programming command from the controller at a factory default address.

6. The sensor of claim 1 wherein the processor is configured to listen for the address programming command from the controller at a previously assigned address.

7. The sensor of claim 1 wherein the processor is configured to listen for the address programming command from the controller at an address selected from among a set of predetermined addresses.

8. The sensor of claim 7 wherein the processor is configured to select the address from among a set of predetermined addresses based at least in part on the measured quantity.

9. The sensor of claim 1 wherein the determining of whether to process the address programming command includes determining if the measured quantity is greater than one of the predetermined threshold values.

10. The sensor of claim 1 wherein the determining of whether to process the address programming command includes determining if the measured quantity is less than one of the predetermined threshold values.

11. The sensor of claim 1 wherein the determining of whether to process the address programming command includes determining if the measured quantity is between two of the predetermined threshold values.

12. The sensor of claim 1 wherein the processor includes one or more latched comparators used for the comparing of the measured quantity to one or more predetermined threshold values.

13. The sensor of claim 1 wherein the processor is further configured to power cycle the sensor after storing the new address.

14. The sensor of claim 1 wherein the processor is further configured to send a response to the controller acknowledging that the address programming command was processed.

15. A system comprising:
a controller connected to a plurality of sensors via a shared bus,
wherein the controller is configured to program an address of at least one of the sensors using a process including:
exciting the sensor above or below one or more predetermined threshold values; and
sending an address programming command, via the shared bus, to a predetermined address at which the sensor is listening.

16. The system of claim 15 wherein the controller is configured to program addresses of two or more sensors of the plurality of sensors using the process.

17. The system of claim 15 wherein the controller is configured to program addresses of all sensors of the plurality of sensors using the process.

18. The system of claim 16 wherein the controller is configured to wait for a first of the two or more sensors to process its address programming command before sending the address programming command to a second of the of the two or more sensors.

19. The system of claim 16 wherein the controller is configured to program the two or more sensors in a substantially parallel fashion.

20. A method comprising:
generating, by a sensor, a signal responsive to a measured quantity;
receiving, by the sensor, an address programming command from a controller via a shared bus, the address programming command including a new address to be assigned to one of a plurality of sensors connected to the controller via the shared bus;
determining, by the sensor, whether to process the address programming command based at least in part on comparing the measured quantity to one or more predetermined threshold values; and
in response to determining to process the address programming command, storing the new address to a non-volatile memory of the sensor.
